(19) United States
(12) Patent Application Publication
(10) Pub. No.: US 2002/0174609 A1
(43) Pub. Date: Nov. 28, 2002

(54) Efficient surge bin structure

(76) Inventor: Martina Shehata, Calgary, AB (US)

Correspondence Address: Martina Shehata, 28 Strathaven Mews SW, Calgary, AB, T3H 2G2, CA

(21) Appl. No.: 09/864,341

(22) Filed: May 25, 2001

(51) Int. Cl. B67D 5/06; E04H 7/00; B65D 43/26

(52) U.S. Cl. 52/192; 52/194; 52/197; 220/262; 222/185.1

(57) ABSTRACT

An advantageous surge bin designed and constructed for the receiving, containing and discharging of bulk materials in which are arranged cooperating circular upper, octagonal intermediate and transitional lower interior wall structures with a discharge opening adapted for closure and discharge and having vertical support and horizontal connecting members so arranged and constructed to beneficially enable an overall structural weight saving of 10% to 15% over conventional designs and to facilitate the relocation of the surge bin by wheeled or other carrier means.

### CROSS-REFERENCE TO RELATED APPLICATIONS

There are no prior filed copending nonprovisional applications (or international applications designating the United States of America) from which this present application derives benefit.

### STATEMENT REGARDING FEDERALLY SPONSORED RESEARCH OR DEVELOPMENT

This subject matter of this application was not supported by any federally sponsored research or development nor do any rights accrue to any federal agencies.

### REFERENCE TO A MICROFICHE APPENDIX

There are no microfiche records required to be included with this application.

### BACKGROUND OF THE INVENTION

In the field of surface mining operations a trend over recent decades has been towards developing large, low grade mineral deposits, typically mined at large daily tonnage rates with increasingly larger units of mining production equipment. Mining haul trucks as large as 350 tons capacity, for example, populate large-scale mining operations such as the Oil Sands mining properties in northern Alberta. Although such “truck and shovel” operations have proven to achieve better mining costs per ton handled than the bucket-wheel excavator and shiftable belt conveyor technology they are replacing, a technical challenge faces the mine planner to convert the cyclical rate of mining ore arrival at the truck dump point into a continuous, steady feed stream suitable for supplying the mining processing plant.

In order to feed a Oil Sands mining plant operating at 6,000 tons per hour, for example, it would require more than 17-350 ton truck loads of ore per hour to keep the plant running at its capacity, equating to one truck dumping on an average of every 3.5 minutes. In fact, the trucks will typically dump at random intervals, including the possibility of two trucks dumping simultaneously into the plant feed system. Conversely, there may be significant time gaps between arriving trucks due to varying haulage distances for individual trucks and due to mechanical breakdowns or other reasons. A primary function of the bulk materials handling system receiving such irregularly timed ore deliveries from the mine must be to provide significant surge capacity configured to receive and hold the mining ore temporarily while continuously feeding a steady stream to the mining plant. Experience in Oil Sands mining demonstrates that a mining plant requiring a feed of 6,000 tons per hour being supplied by 350 ton truck haulage equipment may optimally require 6,000 tons of surge capacity in the form of a surge bin or hopper or other bulk storage container configured to receive ore from the trucks at an irregular rate and to feed the plant at a steady rate.

An additional requirement facing mine operators is the need to relocate the surge bin within the mining areas from time to time as the mining zones advance so as to keep the truck haulage distances to a practical and economic minimum. The surge bin designer not only must design and construct much larger surge bins than in years past at an economic cost, but must also make them portable to facilitate moving the surge bins significant distances by practical means over rough terrain within the mining areas. For both of these reasons it is important for the designer to maximize the capacity to weight ratio of the surge bin.

The discharging function for mining ores from large surge bins at a uniform rate is typically achieved by using large, slow-moving steel pan feeders to control the discharge rate of mining ore from a discharge opening at the bottom of a surge bin. Of the many bulk materials bin discharger mechanisms known to those practiced in the art, the rugged construction of steel pan feeders makes them ideally suited for this service, and for achieving good flow control from large discharge openings in a surge bin, beneficially providing the function of a “live bin bottom” bulk materials bin discharger. A surge bin so equipped with one or more steel pan feeder bulk materials bin dischargers is typically arranged to feed onto a belt conveyor system for delivery of the mining ore to the remote mining plant.

Steel pan apron feeder bulk materials bin dischargers are known to be heavy and costly, causing the surge bin designer to try to minimize the physical size of the discharge opening at the bottom of the surge bin while maximizing the surge bin's contained volume. Conventional surge bins of square, horizontal cross section design typically employ flat, inwardly tapering inclined sidewalls spanning from the top to the bottom of the surge bin. The resulting geometrical shape of a conventional surge bin is somewhat like that of an inverted pyramid with large inclined spans of flat platework which must be reinforced with heavy external structural bracing to carry the internal pressure of the contained bulk materials. A minimum sidewall steepness angle must be maintained in order to achieve desirable mass flow characteristics within the surge bin. Geometrically, the “valley angle” formed at the intersection line of adjacent, sloping sidewalls of the surge bin is less than the sidewall slope itself and also becomes a limiting design factor in avoiding material bridging or freezing or otherwise “hanging-up” along the intersection line of the sidewalls of the surge bin.

The structural weight penalty associated with a typical conventional surge bin of square, horizontal cross section design is uniquely addressed and reduced by the invention described in this application.

### BRIEF SUMMARY OF THE INVENTION

The Efficient Surge Bin Structure constructed according to the preferred embodiments of this invention employs a combination of specific internal wall structures assembled in a specific sequence to maximize the contained volume of the surge bin with a minimum structural weight. The invention relies upon the known structural principle of using tensile “hoop stress” forces to resist internal pressure from contained bulk materials in curved sidewalls rather than relying solely upon the “beam strength” of external structural reinforcements to support spans of flat sidewall plates, advantageously achieving an overall structural weight savings of 10 to 15% over conventional surge bin designs known in the art. The invention also relies upon a specific combination and assembly sequence of dimensionally cooperating internal wall structures enabling the snug assembly and connecting of cylindrical upper, octagonal intermediate and transitional lower wall structures to each other to contain bulk materials without leakage and to achieve favourable bulk material flow characteristics within the contained volumes of the internal wall structures thereof.

The Efficient Surge Bin Structure is defined at least in part by an open top, interior wall structures, a discharge opening adapted for closure and discharge, substantially vertical support columns and horizontal connecting members. The interior wall structures comprise an upper cylindrical wall structure of circular horizontal cross section, an intermediate wall structure having octagonal, horizontal cross section with inclined, inwardly tapering wall portions comprised of adjacent quadrilateral plates and a lower transitional wall structure having inclined, inwardly tapering wall portions comprised of alternating, adjacent triangular and quadrilateral inclined plates to adapt from the octagonal shape of the intermediate wall structure to the substantially square or rectangular shape of the discharge opening.

The upper cylindrical wall structure contains internal pressure from contained bulk materials entirely by converting the internal pressure into resisting tensile “hoop stress” forces carried by the continuous, circular “skin” of the upper wall structure with minimal external reinforcement, thus saving structural weight over a conventional surge bin design requiring substantial external beam structures. The intermediate octagonal wall structure requires external structural beam supports but of shorter spans requiring lighter members than for a conventional surge bin design. The lower transitional wall structure comprised of triangular and quadrilateral plates requires comparable structural bracing to a conventional surge bin design.

In terms of bulk material flow characteristics it should be noted that there are no valley angles to restrict the flow of bulk materials flow in the upper cylindrical wall structure of the Efficient Surge Bin Structure and that the valley angles between adjoining plates in the intermediate octagonal wall structure are less flow-restrictive than in a conventional square surge bin design. These advantageous bulk materials flow characteristics in combination with the overall weight reduction achieved in a surge bin constructed according to the preferred embodiments of this invention are key determinants of the efficiency of the “Efficient Surge Bin Structure” design.

Provisions of the invention facilitating moving the Efficient Surge Bin Structure using practical means within the mining areas will be described in detail during examination of the drawings.

### BRIEF DESCRIPTION OF THE SEVERAL VIEWS OF THE DRAWINGS

The invention is now described with reference to the following Figures in which:

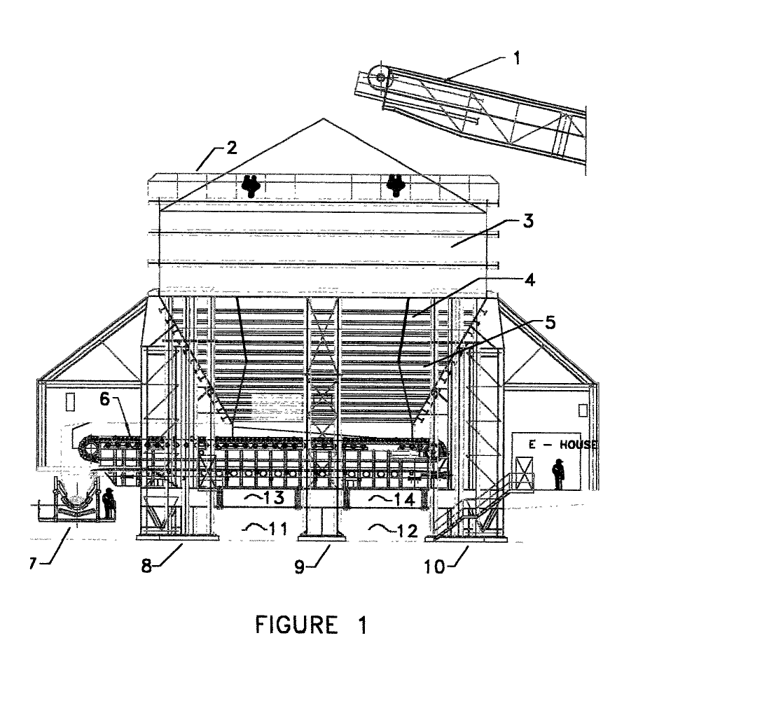

1. FIG. 1 illustrates a surge bin constructed with upper cylindrical, intermediate octagonal and lower transitional internal wall structures arranged according to the preferred embodiments of the invention, with material discharge being controlled by a steel pan feeder bulk materials bin discharger onto a conventional belt conveyor and illustrating external structural members to reinforce the surge bin walls, vertical support members horizontally spaced apart and adapted to support the surge bin structure and horizontal connecting members arranged to facilitate moving the surge bin from place to place;

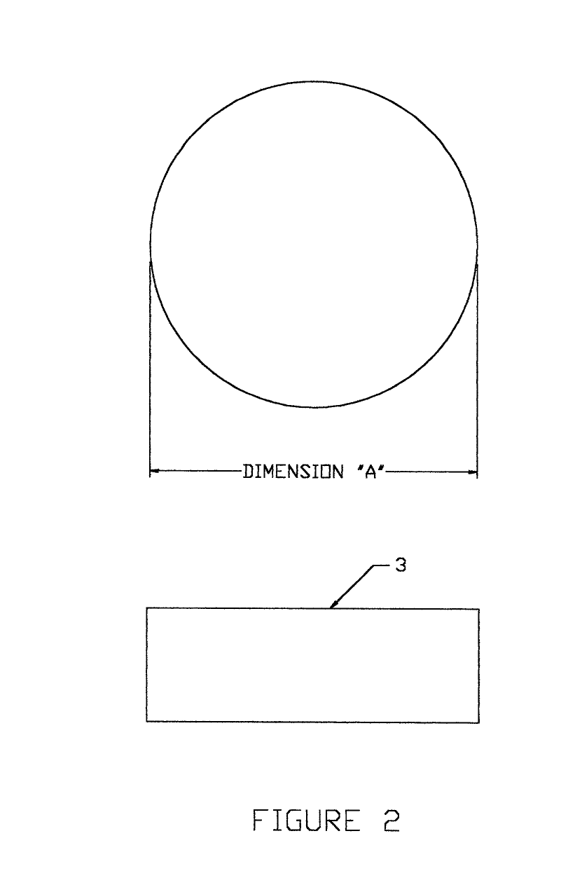

2. FIG. 2 is a simplified drawing in plan and elevation views of the cylindrical upper interior wall structure having a circular, horizontal cross section;

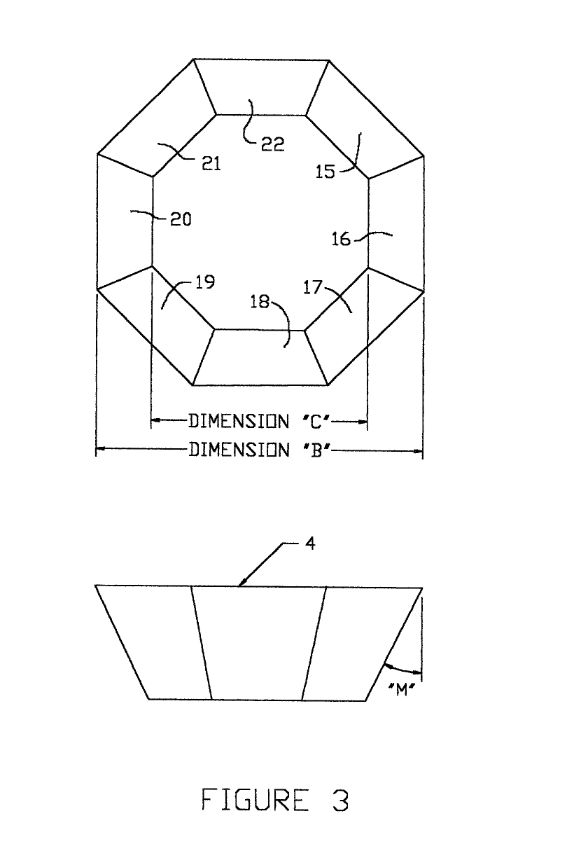

3. FIG. 3 is a simplified drawing in plan and elevation views of the intermediate interior wall structure having octagonal, horizontal cross section with inwardly tapering inclined walls portions constructed of quadrilateral plates;

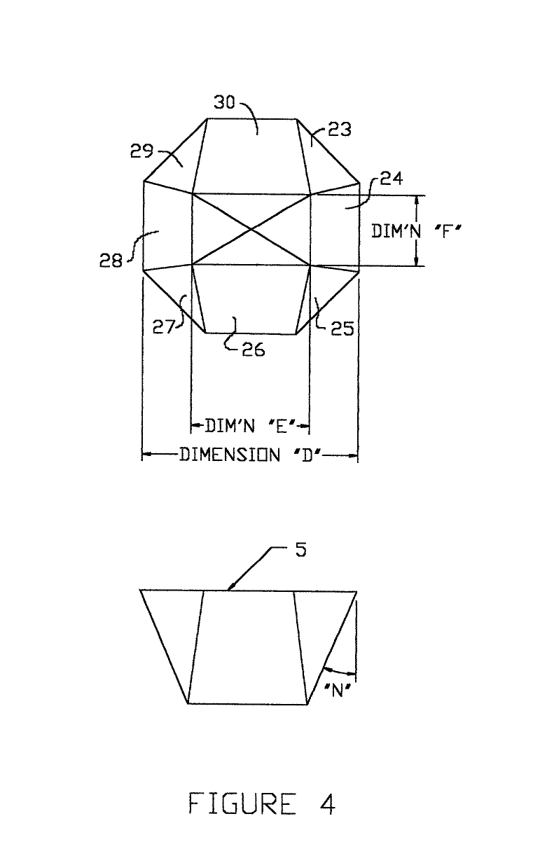

4. FIG. 4 is a simplified drawing of the lower transitional interior wall structure of the surge bin having octagonal, horizontal cross section in its upper portions with inwardly tapering inclined wall portions comprised of alternating, adjacent triangular and quadrilateral plates arranged to form a substantially square or rectangular discharge opening in a substantially horizontal plane at the bottom of the lower transitional structure;

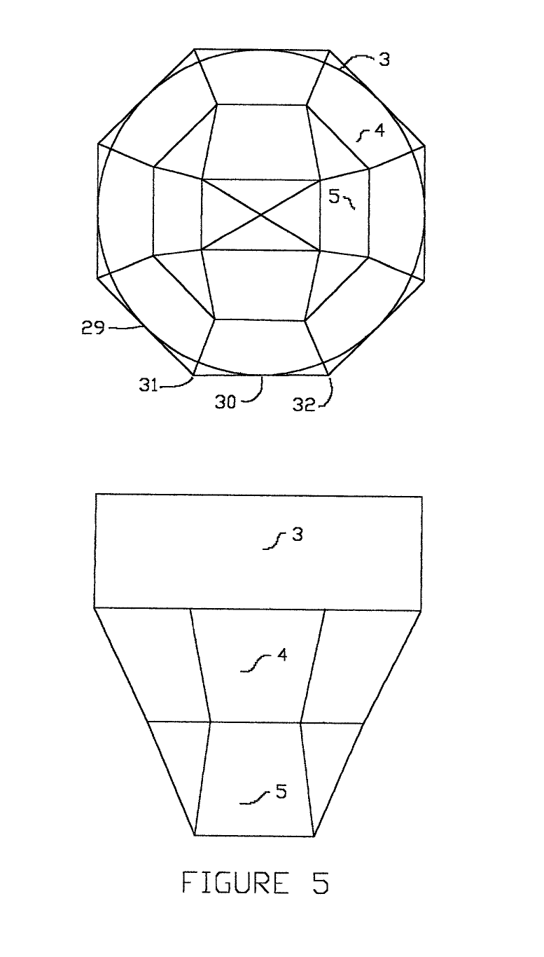

5. FIG. 5 is a simplified drawing in plan and elevation views of the assembly of the upper cylindrical structure, the intermediate octagonal structure and the lower transitional structure of the High Efficiency Surge Bin;

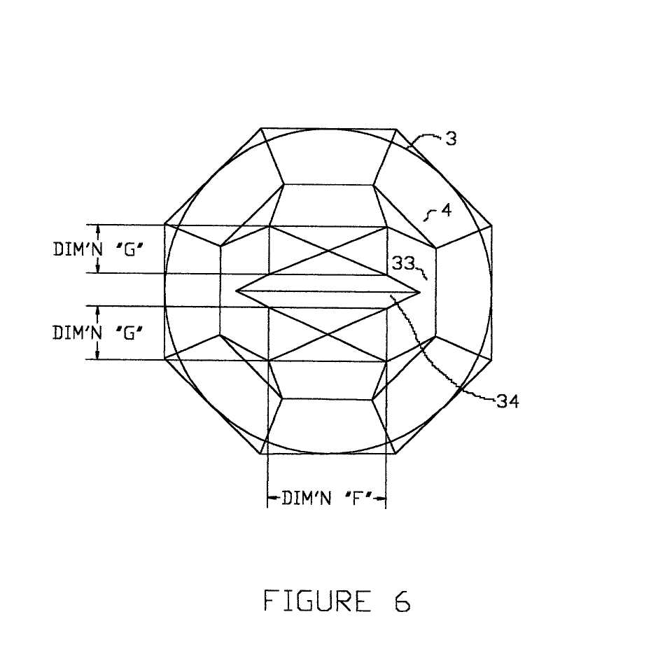

6. FIG. 6 is a simplified drawing in plan view of an assembly of the upper cylindrical structure, the intermediate octagonal structure and an alternate lower transitional structure of the surge bin having two substantially rectangular discharge openings at the bottom of the lower transitional structure.

### DETAILED DESCRIPTION OF THE INVENTION

The overall concept of the Efficient Surge Bin Structure can be seen in FIG. 1 in which an inclined bulk feed conveyor 1 feeds mined ore or other bulk material from a truck dump or other feed source (not shown) discharging into an open topped surge bin 2 comprising an upper cylindrical structure 3, an intermediate octagonal structure 4, a transitional lower structure 5 adapted to feed a steel pan feeder bulk materials bin discharger 6, itself supported and arranged to feed bulk materials contained in the surge bin to a conventional belt conveyor 7 known in the art for feeding a remote mining plant or other feed recipient entity (not shown). Generally at the perimeter of the surge bin are arranged and attached substantially vertical support members 8, 9 and 10 bearing the live and dead weights of the surge bin down to foundations. Between ones of the vertical support members are provided horizontal openings 11 and 12 under and through the surge bin structure suitable to admit wheeled or other carrier vehicles (not shown) equipped with lifting devices capable of engaging horizontal connecting members 13 and 14 attached at least between ones of said substantially vertical support members to facilitate lifting and moving the surge bin to an alternate location. Other illustrated features such as the insulated metal cladding, the electrical house and the spillage conveyor are not material to a description of this invention.

The simplified drawing of FIG. 2 shows the internal geometric shape of the upper cylindrical wall structure 3 having internal diameter “A”.

The simplified drawing of FIG. 3 shows the internal geometric shape of the intermediate wall structure 4 having octagonal, horizontal cross section with an internal dimension “B” across the upper face of the intermediate wall structure equal to internal diameter “A” of the upper cylindrical wall structure and internal dimension “C” at the lower face of the intermediate wall structure and being made up of inwardly tapering inclined wall portions comprised of quadrilateral plates 15, 16, 17, 18, 19, 20, 21 and 22; said adjacent plates being joined by welding or other known means at valley angles between them and said quadrilateral plate dimensions chosen to generate a desirable “steepness” angle “M” to the vertical to promote bulk materials flow.

The simplified drawing of FIG. 4 shows the internal geometric shape of the lower transitional wall structure 5 having an internal dimension “D” across the upper face of the lower transitional structure equal to dimension “C” across the lower face of the intermediate octagonal wall structure and being made up of inwardly tapering inclined wall portions comprised of adjacent triangular and quadrilateral plates 23, 24, 25, 26, 27, 28, 29 and 30; said adjacent plates being joined by welding or other known means at valley angles between them, said triangular and quadrilateral plates having dimensions chosen to generate desirable steepness angles to the vertical such as at “N” to promote bulk materials flow and forming a substantially horizontal discharge opening at its lowermost portion having dimensions “E” and “F” selected to suit the installation of a steel pan apron feeder bulk materials bin discharger (not shown) mounted in close proximity below said opening.

In the simplified surge bin assembly drawing of FIG. 5 it should be noted that dimension “B” of intermediate octagonal wall structure 4 was selected to equal diameter “A” of the upper cylindrical wall structure 3 such that the upper wall structure can be snugly assembled and connected to the intermediate wall structure at eight contact points therebetween such as are shown, for example, at tangency points 29 and 30. The apex points of the octagonal intermediate wall structure such as are shown, for example at 31 and 32 therefore fall outside of the internal diameter of the upper wall structure in plan view thus preventing leakage of contained bulk materials during use of the surge bin. Also, dimensions “C” and “D” of the intermediate octagonal and lower transitional wall structures, respectively, are selected to be dimensionally equal such that the lower octagonal face of intermediate wall structure 4 can be correspondingly oriented, snugly assembled and sealingly joined by welding or other known means to the upper octagonal face of the lower transitional wall structure 5.

In the simplified surge bin assembly plan view drawing of FIG. 6 an alternate lower transitional interior wall structure 33 of the surge bin is adapted to have two substantially rectangular discharge openings in a substantially horizontal plane at the bottom of the surge bin. The openings having dimensions “F” and “G” are separated by an internal divider plate member 34 and are thus beneficially configured to suit the installation of two parallel steel pan feeder bulk materials bin dischargers mounted in close proximity below the discharge openings. The said internal divider plate member is installed in a substantially horizontal orientation and constructed of plates forming an inverted vee in cross section having a favourable internal steepness angle to promote flow of bulk materials discharging from the surge bin and being conveniently supported internally of the lower transitional wall portions between opposing ones of said quadrilateral plates immediately above the substantially horizontal plane of the discharge openings.

It will be clear to those skilled in the art that an upper, truncated conical interior wall structure could be substituted in place of the upper cylindrical interior wall structure, providing that the internal diameter of the lower face of the truncated conical structure was made equal to the internal diameter of the cylindrical section it replaced, enabling it to be snugly assembled and connected to the intermediate octagonal wall structure at contact points therebetween, since the mechanism of resisting internal pressure from contained bulk materials by converting said internal pressure into resisting tensile “hoop stress” forces within the “skin” of the internal wall structure is the same for either cylindrical or conical geometric shapes of wall structure.

It will also be clear to those skilled in the art that the intermediate, octagonal wall structure could be omitted entirely from the said assembly sequence of interior wall structures, if the interior diameter of the upper cylindrical wall structure was constructed to be dimensionally equal to the minimum interior distance across the upper octagonal face of the lower transitional wall structure, said upper and said lower interior wall structures being snugly assembled and connected at contact points therebetween.

It will also be obvious to those skilled in the art that other assembly sequences and combinations of interior wall structures including, for example, the combination of upper cylindrical, intermediate conical and lower transitional wall structures snugly assembled and connected or sealingly joined at dimensionally cooperating faces therebetween also fall within the spirit of the invention in that said cylindrical and said conical wall structures convert internal pressure from contained bulk materials into resisting tensile “hoop stress” forces within the “skin” of their respective internal wall structures, thereby eliminating the need for external beam structures to support the flat wall portions characterizing a conventional surge bin design.

By this specification I have disclosed the construction plan of an advantageous surge bin design for the receiving, containing and discharging of bulk materials comprised of vertical and inclined internal wall structures in which dimensionally cooperative upper, intermediate and lower interior wall structures are arranged and connected according to the preferred embodiments of the invention and in which the lower structural portions of the surge bin are so constructed as to facilitate relocating the surge bin by wheeled or other carrier means.

What I claim as my invention is:

1. A surge bin arranged for the receiving, containing and discharging of bulk materials and defined at least in part by an open top, interior wall structures and a discharge opening adapted for closure and discharge, substantially vertical support columns and horizontal connecting members,
said interior wall structures being comprised of the cooperating assembly of vertical and inclined interior wall structures including
an upper cylindrical interior wall structure having a lower circular face and a circular, horizontal cross section with continuous vertical wall portions and an open top,
an intermediate interior wall structure having upper and lower octagonal faces and octagonal, horizontal cross section with inwardly tapering inclined wall portions comprised of adjacent quadrilateral plates joined along valley angles between said adjacent plates,
a lower transitional interior wall structure having an upper octagonal face and octagonal, horizontal cross sections in its upper portions with inwardly tapering inclined wall portions comprised of alternating, adjacent quadrilateral and triangular plates joined along valley angles between said adjacent plates and arranged to form a substantially square or rectangular discharge opening in a substantially horizontal plane at the bottom of said lower transitional interior wall structure,
said upper cylindrical interior wall structure having an interior diameter at its said lower face equal to the minimum interior horizontal distance across said upper face of said intermediate interior wall structure, said upper cylindrical and said intermediate octagonal interior wall structures being snugly assembled at said lower and said upper faces and connected at contact points therebetween,
said intermediate octagonal interior wall structure having said lower octagonal face dimensionally corresponding with said upper octagonal face of said lower transitional interior wall structure, said intermediate octagonal and said lower transitional interior wall structures being correspondingly oriented and snugly assembled at said upper and said lower faces and sealingly connected therebetween,
said substantially square or rectangular discharge opening of said lower transitional interior wall structure being adapted for closure and discharge by the mounting and operation of a bulk materials bin discharger mechanism supported below and in close proximity to the discharge opening,
said substantially vertical support columns being arranged and attached around the perimeter of said surge bin in a horizontally spaced apart relationship to bear the live and dead weight of said surge bin down to foundations and holding said surge bin in a vertically elevated position above ground level, and
said horizontal connecting members being attached between said substantially vertical support columns generally at a lower elevation of said columns but maintaining a vertical clearance above ground level.

2. A surge bin constructed as in claim 1 in which the upper interior wall structure has the alternate geometric shape of a truncated cone with an open top, a lower face and continuous, inwardly tapering inclined wall portions having an interior diameter at said lower face of said conical interior wall structure equal to the minimum interior horizontal distance across the upper face of said intermediate interior wall structure, said upper conical and said intermediate octagonal interior wall structures being snugly assembled at said lower and said upper faces and connected at contact points therebetween.

3. A surge bin constructed as in claim 1 in which said intermediate, octagonal interior wall structure is omitted from the assembly sequence of the said upper, said intermediate and said lower interior wall structures, the interior diameter of said upper cylindrical interior wall structure at said lower face being constructed to be dimensionally equal to the minimum interior horizontal distance across the upper octagonal face of said lower transitional interior wall structure, said upper and said lower interior wall structures being snugly assembled at said lower and said upper faces and connected at contact points therebetween.

4. A surge bin constructed as in claim 1 in which said substantially square or rectangular discharge opening at the bottom of said lower transitional interior wall structure is further divided into at least two discharge openings formed by the internal arrangement of at least one substantially horizontal bridging member mounted internally to opposite ones of said inwardly tapering quadrilateral inclined wall plates, each of said discharge openings being adapted for closure and discharge by the mounting and operation of individual bulk materials bin discharger mechanisms supported below and in close proximity to the discharge openings.

5. A surge bin constructed as in claim 1 or claim 4 in which at least one of said bulk materials bin discharger mechanisms is a steel pan apron feeder.

6. A surge bin constructed as in claim 1 in which said horizontal spaces with said vertical clearances are arranged to form openings under and through the surge bin structure to admit one or more wheeled or other carrier vehicles equipped with lifting devices to enter said spaces with said clearances under said surge bin and to engage said horizontal connecting members with said lifting devices for purposes of lifting said surge bin for transportation to an alternate location.
